(19) United States
(12) Patent Application Publication
(10) Pub. No.: US 2015/0024763 A1
(43) Pub. Date: Jan. 22, 2015

(54) METHODS OF RESOURCE MANAGEMENT FOR DEVICE-TO-DEVICE COMMUNICATIONS

(71) Applicant: Electronics & Telecommunications Research Institute, Daejeon (KR)

(72) Inventors: Jun Hwan LEE, Seoul (KR); Tae Soo KWON, Daejeon (KR); Ji Hyung KIM, Daejeon (KR)

(21) Appl. No.: 14/335,088

(22) Filed: Jul. 18, 2014

(30) Foreign Application Priority Data
Jul. 18, 2013 (KR) 10-2013-0084655
Jul. 16, 2014 (KR) 10-2014-0089552

(51) Int. Cl. H04W 72/08; H04W 72/04

(52) U.S. Cl. CPC H04W 72/082; H04W 72/0413; H04W 72/0453
USPC 455/450

(57) ABSTRACT

Disclosed is a resource management method for communications between moving objects. A method of resource management, performed in a terminal, comprises determining resource state of each subband included in resources allocated for device-to-device (D2D) communications, wherein the resources are divided into a plurality of subbands; configuring resource state information indicating resource state of each subband of the plurality of subbands; and transmitting the resource state information to a base station. Thus, a system capacity can be increased in a mobile communication environment where communications between terminals and a base station and D2D communications between terminals coexist.

### CLAIM FOR PRIORITY

This application claims priorities to Korean Patent Applications No. 10-2013-0084655 filed on Jul. 18, 2013, and No. 10-2014-0089552 filed on Jul. 16, 2014 in the Korean Intellectual Property Office (KIPO), the entire contents of which are hereby incorporated by reference.

### BACKGROUND

1. Technical Field

Example embodiments of the present invention relate in general to a mobile communication technology, and more specifically, to a method of resource management for device-to-device communications between mobile stations.

2. Related Art

Direct communications between mobile stations is being studied in aspects of system capacity enhancement and public safety. Especially, a device-to-device communication technology is being focused upon. The device-to-device (hereinafter, referred to as a ‘D2D’) communication is a technology enabling mobile terminals such as a smartphone to directly communicate with each other.

The D2D communication technology is based on physical proximity between terminals, and has many advantages in aspects of network resource efficiency enhancement, decrease of terminal power consumption, cellular communication coverage expansion, etc. The mobile communication standard organization 3rd Generation Partnership Project (3GPP) has adopted the D2D as a study item of Long Term Evolution (LTE)-Advanced Release-12, and is taking the standardization of the D2D communication technology.

If the D2D communication is commercialized, innovative changes are expected in various service domains such as Social Network Service (SNS), crime prevention, game, etc. Meanwhile, if the D2D communication is commercialized, communications become possible even when emergency situations such as disaster, war, etc. occur and mobile communication networks are destroyed. Thus, a communication environment in which communications for social security becomes possible without separate infrastructures for social security.

The D2D communication technology of the LTE system is a technology that terminals located within a near distance can directly communicate with each other. In the conventional cellular communication system, a terminal should communicate with another terminal through a base station without regard to a distance between the terminals. However, the D2D communication technology makes terminals or devices located adjacently exchange data directly without intervention of the base station. At this time, the base station may provide the terminals located adjacently with an environment where the terminals can directly communicate with each other.

The currently considered D2D communication technology uses uplink frequency band as D2D communication resource in a cellular network based on Frequency Division Duplexing (FDD). Also, it may adopt a half duplexing communication manner in consideration of complexity and power consumption of a terminal or a device.

Meanwhile, in the environment where terminals performing D2D communications and terminals performing cellular communications coexist, interferences between terminals may occur. In order to cancel or manage the interferences, a method that the base station obtains characteristics of channels between terminals and the base station and characteristics of channels between terminals, and manages the D2D communications based on the obtained information on channel characteristics may be used. However, for this, amount of channel state information which terminals should report to the base station increases excessively whereby efficiency of resource use decreases and accordingly system capacity decreases. Therefore, the above-described method is difficult to be applied to an actual communication environment.

### SUMMARY

Accordingly, example embodiments of the present invention are provided to substantially obviate one or more problems due to limitations and disadvantages of the related art.

Example embodiments of the present invention provide methods for resource management which can enhance efficiency of resource use and increase capacity of a mobile communication system, in a mobile communication environment where cellular communications between terminals and a base station and D2D communications between terminals coexist.

In some example embodiment, a method of resource management, performed in a terminal, may comprise determining resource state of each subband included in resources allocated for device-to-device (D2D) communications, wherein the resources are divided into a plurality of subbands; configuring resource state information indicating resource state of each subband of the plurality of subbands; and transmitting the resource state information to a base station.

Here, the method may further comprise receiving information on the resources allocated for D2D communications from the base station, wherein the information on the resources allocated for D2D communications includes information on a frequency band used for the D2D communications among total uplink frequency bands and information on the subbands into which the frequency band used for the D2D communications is divided.

Here, the determining resource state of each subband may include measuring interference level of each subband; and determining whether the each subband can be used by comparing the interference level with a threshold value. Also, the threshold value may be determined according to a Modulation and Coding Scheme (MCS) which is applied to the D2D communications. Also, the resource state information may include a bitmap each bit of which indicates whether a corresponding subband can be used.

Here, the size of the bitmap is determined according to the number of MCS levels which are applied to the D2D communications.

In other example embodiment, a method of resource management, performed in a first terminal, may comprise determining resource state of each subband included in resources allocated for device-to-device (D2D) communications, wherein the resources are divided into a plurality of subbands; configuring first resource state information indicating resource state of each subband of the plurality of subbands; transmitting the first resource state information to a second terminal; receiving second resource state information configured by the second terminal from the second terminal; and determining a resource for the D2D communications based on the first resource state information and the second resource state information.

Here, the resources allocated for D2D communications may be a frequency band selected among total uplink frequency bands, and the frequency band may be divided into a plurality of subbands.

Here, configuring the first resource state information may include measuring interference level of each subband; determining whether the each subband can be used by comparing the interference level with a threshold value; and configuring the first resource state information including a bitmap each bit of which indicates whether a corresponding subband can be used.

In still other example embodiment, a method of resource management, performed in a base station, may comprise allocating a portion of total uplink frequency bands for resources for device-to-device (D2D) communications; dividing the resources for D2D communications into a plurality of subbands; transmitting information on the resources for D2D communications and the plurality of subbands to at least one terminal performing the D2D communications; receiving resource state information on the plurality of subbands from the at least one terminal performing the D2D communications; and scheduling uplink resources for at least one terminal accessing the base station based on the resource state information.

Here, the resource state information may include a bitmap each bit of which indicates resource state of a corresponding subband. Also, the resource state may indicate whether a corresponding subband can be used.

Here, the size of the bitmap is determined according to the number of Modulation and Coding Scheme (MCS) levels which are applied to the D2D communications.

According to the above-described resource management method for communications between moving objects, provided is a method for identifying interferences between cellular communication links and D2D communication links and interferences between D2D communication links. Also, the present invention provides a method for defining bitmap information which can indicate states of D2D communication resources based on the identified interferences and configuring the bitmap information. Also, the present invention provides a resource allocation method based on the bitmap information.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating a mobile communication environment to which a resource management method according to an example embodiment of the present invention is applied;

FIG. 2 is a conceptual diagram to explain D2D resources used in a resource management method according to an example embodiment of the present invention;

FIG. 3 is a conceptual diagram illustrating a resource management method according to an example embodiment of the present invention;

FIG. 4A and FIG. 4B are conceptual diagrams illustrating examples of state information configuration of D2D communication resources used for a resource management method of the present invention;

FIG. 5 is a flow chart illustrating a resource management method according to an example embodiment of the present invention; and

FIG. 6 is a flow chart illustrating a procedure for selecting D2D communication resources used by terminals performing D2D communications in a resource management method according to an example embodiment of the present invention.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

The term “terminal” used in this specification may be referred to as User Equipment (UE), a User Terminal (UT), a wireless terminal, an Access Terminal (AT), a Subscriber Unit (SU), a Subscriber Station (SS), a wireless device, a wireless communication device, a Wireless Transmit/Receive Unit (WTRU), a mobile node, a mobile, or other words. The terminal may be a cellular phone, a smart phone having a wireless communication function, a Personal Digital Assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, or also a portable unit or terminal having a combination of such functions. However, the terminal is not limited to the above-mentioned units.

Also, the term “base station” used in this specification means a fixed point that communicates with terminals, and may be referred to as another word, such as Node-B, eNode-B, a base transceiver system (BTS), an access point, etc. Also, the term “base station” means a controlling apparatus which controls at least one cell. In a real wireless communication system, a base station may be connected to and controls a plurality of cells physically, in this case, the base station may be regarded to comprise a plurality of logical base stations. That is, parameters configured to each cell are assigned by the corresponding base station.

Also, the term “network” used in this specification may include a mobile internet such as a Wireless Fidelity (WIFI), a Wireless Broadband Internet (WiBro), and a World Interoperability for Microwave Access (WiMax). Also, it may include 2G cellular network such as a Global System for Mobile communication (GSM) and a Code Division Multiple Access (CDMA), 3G cellular network such as a Wideband Code Division Multiple Access (WCDMA) and a CDMA2000. Also, it may include 3.5G cellular network such as a High Speed Downlink Packet Access (HSDPA) and a High Speed Uplink Packet Access (HSUPA). Also, it may include 4G or beyond 4G cellular network such as a Long Term Evolution (LTE) and a LTE-Advanced.

Hereinafter, embodiments of the present invention will be described in detail with reference to the appended drawings. In the following description, for easy understanding, like numbers refer to like elements throughout the description of the figures, and the same elements will not be described further.

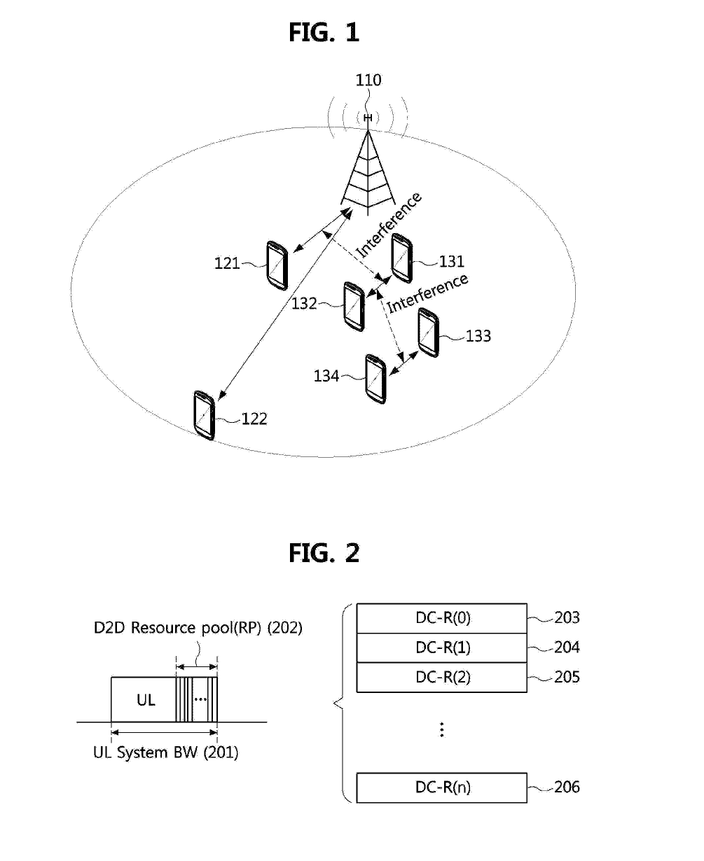

FIG. 1 is a conceptual diagram illustrating a mobile communication environment to which a resource management method according to an example embodiment of the present invention is applied.

A resource management method according to the present invention may be applied to a mobile communication environment in which cellular communications between a base station 110 and terminals 121 and 122 and device-to-device (hereinafter, referred to a s ‘D2D’) communications between terminals 131, 132, 133, and 134 coexist.

In FIG. 1, it is assumed that the terminals 121 and 122 perform conventional cellular communications with the base station 110, and the terminals 131 to 134 perform D2D communications without intervention of the base station 110.

The terminals 131 to 134, which are performing D2D communications, may use uplink frequency band (i.e. uplink resources).

Here, the D2D communications between the terminals 131 and 132 may give interferences to the D2D communications between the terminals 133 and 134. Also, the D2D communications between the terminals 133 and 134 may give interferences to the D2D communications between the terminals 131 and 132. Also, the D2D communications between the terminals 131 and 132 may give interferences to communications between the adjacent terminal 121 and the base station 110 and communication between the adjacent terminal 122 and the base station 110.

Thus, if the interferences between terminals performing D2D communications and the interferences between terminals performing D2D communications and terminals performing cellular communications (that is, terminals performing communications with the base station) are not efficiently canceled or managed, increase of system capacity through the D2D communications cannot be expected.

Thus, for the mobile communication environment where interferences exist as shown in FIG. 1, the present invention may provide a resource management method which can maximize a frequency reuse ratio by efficiently allocating resources for cellular communications and D2D communications in consideration of states of resources used for each of communication links.

FIG. 2 is a conceptual diagram to explain D2D resources used in a resource management method according to an example embodiment of the present invention.

FIG. 2 illustrates a case in which resources for D2D communications are allocated as fixed among frequency bandwidth used for uplink transmission, in the mobile communication environment where cellular communications and D2D communications coexist, as shown in FIG. 1.

Referring to FIG. 2, a portion 202 (i.e. a D2D resource pool) of the total uplink system bandwidth 201 may be used for D2D communications as fixed. Here, the size and area of the D2D resource pool 200 may be changed semi-statically by a base station based on channel states. In case that the D2D resource pool 202 is changed, the base station may transmit the changed information to terminals through system information such as a System Information Block (SIB). Alternatively, the base station may change the D2D resource pool 202 dynamically according to channel states or network situations. In this case, the base stations can dynamically perform a signaling on the changed information.

In FIG. 2, total uplink system bandwidth 201 may be used for communications between the base station and terminals, and only the D2D resource pool 202 among the total system bandwidth 201 may be used for D2D communications.

Also, the D2D resource pool 202 may be divided into several subbands thereby being configured as multiple D2D communication resources (hereinafter, referred to as ‘DC-R’) 203 to 206. Here, the number of DC-R may be changed according to the total uplink system bandwidth, and each DC-R may be configured with several physical resource blocks (PRB).

In the present invention, as shown in FIG. 2, a portion of the total uplink system bandwidth may be allocated for D2D communication as a fixed D2D resource pool, and the allocated D2D resource pool may be managed as divided into several subbands (that is, DC-Rs).

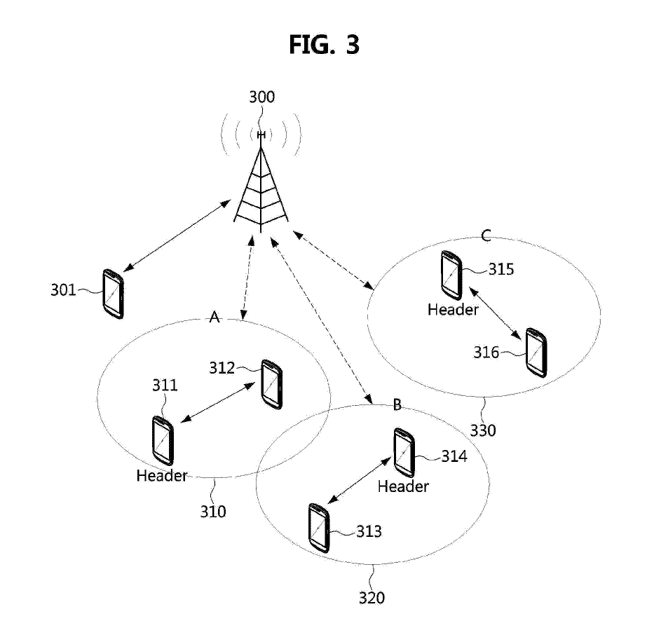

FIG. 3 is a conceptual diagram illustrating a resource management method according to an example embodiment of the present invention.

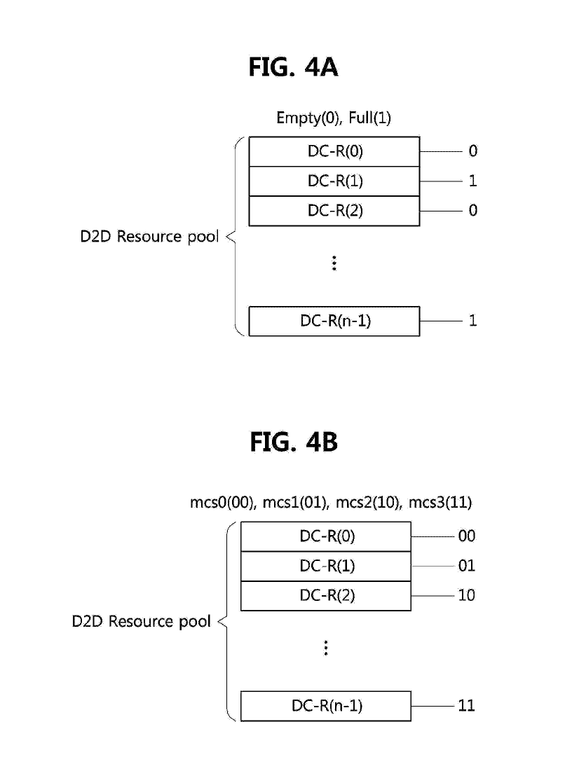

Also, FIG. 4A and FIG. 4B are conceptual diagrams illustrating examples of state information configuration of D2D communication resources used for a resource management method of the present invention.

Hereinafter, the resource management method according to the present invention will be explained in further detail by referring to FIGS. 3, 4A, and 4B.

In FIG. 3, a cellular communication link between a base station 300 and a terminal 301 and D2D communication links between terminals 311 to 316 coexist. Also, the terminals 311 to 316, performing D2D communications, may be divided into three groups 310, 320, and 330. Here, the D2D communication groups 310, 320, and 330 may be configured according to various criteria. For example, the D2D communication groups may be configured according to physical positions of the terminals performing D2D communications and resources used by terminals performing D2D communications or pairs of terminals performing D2D communications.

Also, in FIG. 3, although it is assumed that three D2D communication groups exist and each D2D communication group comprises two terminals, it is an example only for convenience of explanation. Actually, there is no restriction on the number of D2D communication groups existing in a service coverage operated by a single base station. Also, each D2D communication group may include three or more terminals, and include various communication links such as Point to Point (P2P), Point to Multi-point (P2M), and Multi-point to Point (M2P). That is, the number of terminal belonging to each D2D communication group is not restricted to 2, and terminals belonging to each D2D communication group may also perform a multicasting or a groupcasting.

A terminal belonging to each D2D communication group may perform a function of a D2D header 311, 314, or 315. Here, the function of D2D header may be to perform control signaling with the base station as a representative of each D2D communication group. Hereinafter, a terminal performing the D2D header function is referred to as a ‘header terminal.’

While the base station is receiving data transmitted by the terminal 301 through the uplink frequency band, the terminal 311 located adjacent to the terminal 301 identifies an adjacent terminal 312, and establishes a D2D communication link with the terminal 312. Here, it is assumed that the terminals 311 and 312 belong to the D2D communication group 310, and the terminal 311 is a header terminal of the D2D communication group 310. Also, it is assumed that the terminals 313 and 314 establish their D2D communication link in the D2D communication group 320 and the terminal 314 is a header terminal of the D2D communication group 320. Also, it is assumed that the terminals 315 and 316 establish their D2D communication link in the D2D communication group 330 and the terminal 315 is a header terminal of the D2D communication group 330.

The header terminals 311, 314, and 315 of the D2D communication groups 310, 320, and 330 may measure interference level (e.g. interference over thermal (IoT)) for each subband (i.e. for each DC-R) of resources allocated for D2D communications (i.e. D2D resource pool.) Here, each header terminal 311, 314, or 315 may measure interference level for each subband as a Received Signal Strength Indicator (RSSI.) Meanwhile, a Sounding Reference Signal (SRS), which is used for determining uplink channel characteristics in the conventional LTE system, may be used for terminals performing D2D communications to measure interference. However, since it requires excessive computation, it is difficult that the SRS is used for measuring interferences in actual D2D communication environment.

As described above, a header terminal 311, 314, or 315 of each D2D communication group 310, 320, or 330 may measure interference level of each subband of resources allocated for D2D communications thereby identifying resource states of subbands respectively. Here, the state may mean information on whether each subband can be used for D2D communications. In other words, if interference of a subband is small, the corresponding subband can be used for D2D communications. Otherwise, if interference of a subband is large, the corresponding subband cannot be used for D2D communication.

After each header terminal 311, 314, or 315 determines resource states of subbands of resources allocated for D2D communications respectively, it may configure resource state information for all subbands. Here, each header terminal 311, 314, or 315 may configure the state information for all subbands in a bitmap form as represented in FIGS. 4A and 4B.

A header terminal may configure the bitmap by applying a predetermined threshold value. Here, the threshold value may be determined by considering a Modulation and Coding Scheme (MCS) level which can be applied to D2D communications.

As shown in FIG. 4A, a header terminal may represent (or, indicate) resource state of each subband by using a single bit. At this time, 1 bit may represent whether the corresponding subband can be used or not. In FIG. 4A, a header terminal may set a bit value corresponding to DC-R(0) to 0 when interference level of DC-R(0) is lower than the threshold value. In this case, the value ‘0’ means that DC-R(0) subband can be used (i.e. ‘Empty’.) Otherwise, when interference level of DC-R(1) is equal to or greater than the threshold value, a header terminal may set a bit value corresponding to DC-R(1) to 1, and the value ‘1’ means that DC-R(1) subband cannot be used (i.e. ‘Full’.)

Meanwhile, if multi-leveled MCS is used for a D2D communication link by considering Quality of Service (QoS) differentiation, the header terminal may allocate multiple bits for each subband in order to represent resource state for each subband. In this case, the header terminal may compare interference level of each subband with multiple threshold values in stepwise manner, and indicate state information for each subband.

For example, as shown in FIG. 4B, when four MCS levels MCSO, MCS1, MCS2, and MCS3 are used for D2D communications, a header terminal may use 2 bits for each subband in order to represent channel state of each subband. For example, if interference level of DC-R(0) corresponds to MCSO, a header terminal may set a value for DC-R(0) to be ‘00’. Also, if interference level of DC-R(1) corresponds to MCS1, a header terminal may set a value for DC-R(1) to be ‘01’. Also, if interference level of DC-R(2) corresponds to MCS2, a header terminal may set a value for DC-R(2) to be ‘10’. Also, if interference level of DC-R(n-1) corresponds to MCS3, a header terminal may set a value for DC-R(n-1) to be ‘11’.

Each header terminal of each D2D communication group may transmit the bitmap information which is configured as described above to the base station. Here, each header terminal may transmit the bitmap information to the base station through Physical Uplink Control Channel (PUCCH).

Then, the base station receives the bitmap information from each header terminal of each D2D communication group, and uses the received bitmap information for scheduling on uplink resources.

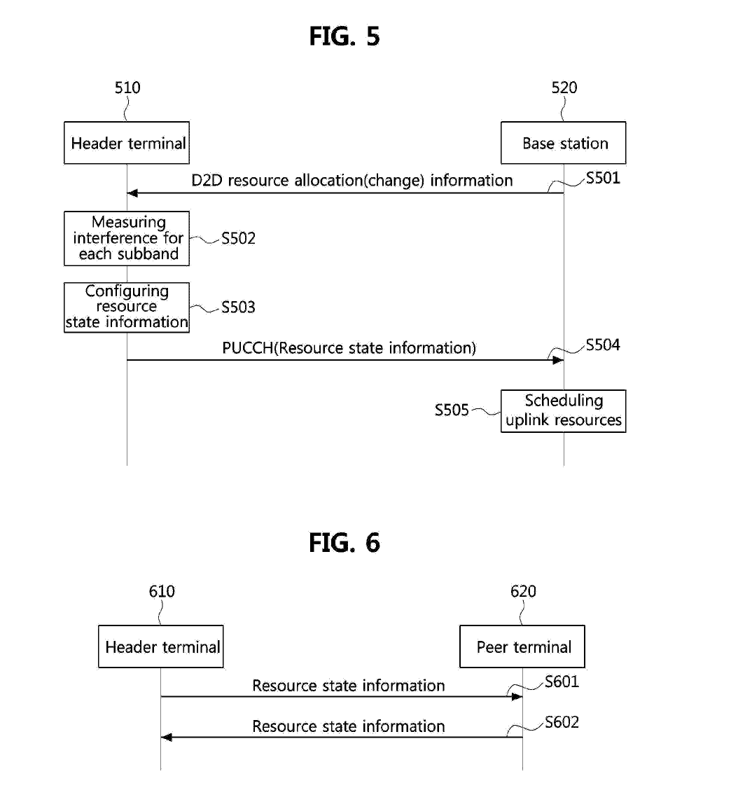

FIG. 5 is a flow chart illustrating a resource management method according to an example embodiment of the present invention. In FIG. 5, illustrated is an example of operations performed by a header terminal 510 belonging to a D2D communication group and a base station 520 in the communication environment shown in FIG. 3.

Referring to FIG. 5, the base station 520 transmits D2D resource allocation information to at least one terminal (S501). Here, the D2D resource allocation information may include information on uplink frequency band allocated for D2D communications (i.e. information on a D2D resource pool) and information on D2D communication resources (i.e. DC-Rs) into which the uplink frequency band is divided. The base station 520 may transmit the D2D resource allocation information as included in system information (SI). Also, when the D2D resource allocation information is changed, the base station 520 may inform the header terminal 510 of the changed information.

The header terminal 510 may obtain the information on uplink frequency band allocated for D2D communications and the information on D2D communication resources based on the D2D resource allocation information received from the base station 520.

The header terminal may measure interference level (IoT) for each subband (i.e. each DC-R) of the uplink frequency band allocated for D2D communications based on the obtained information (S502). Here, the header terminal 510 may measure RSSI for each subband as the interference level for each subband.

Then, the header terminal 510 may configure bitmap information representing resource state of each subband based on the measured interference level for each subband (S503). A method for configuring the bitmap information is identical to the method explained referring to FIG. 4A and FIG. 4B.

Then, the header terminal 510 may transmit the bitmap information to the base station 520 (S504). Here, the header terminal may transmit the bitmap information to the base station 520 by using PUCCH.

Then, the base station receives the bitmap information from the header terminal 510, and performs scheduling on uplink transmission of a terminal which accesses the base station 520 based on the received bitmap information (S505). Here, the base station 520 may identify use state of each subband (DC-R) belonging to the uplink frequency band allocated for D2D communications (D2D resource pool) based on the received bitmap information, and perform the scheduling based on the identified use states according to a frequency reuse method.

Also, the base station 520 may transmit the received bitmap information to all terminals belonging to its cell in order to efficiently allocate D2D resources by considering patterns (referring to FIG. 1) of interferences between cellular links between the base station and terminals and D2D communication links between terminals. In this case, it becomes possible to remove interferences between a communication link of the base station and a terminal located near and D2D links and interferences between a communication link of the base station and a terminal located far and D2D links.

In FIGS. 3 to 5, each header terminal belonging to each D2D communication group measures interference level of each subband, configures bitmap information corresponding to the measurement results, and transmits the configured bitmap information to the base station. However, any other terminal belonging to a D2D communication group may perform the measurement and the configuration of the bitmap information. That is, any other terminal which is not a header terminal and belongs to each D2D communication group may measure interference level of each subband, configure bitmap information corresponding to the measurement results, and transmit the configured bitmap information to the base station.

Meanwhile, all terminals participating D2D communications, among terminals belonging to each D2D communication group, may measure interference (IoT) of each subband (i.e. DC-R) of allocated resources (i.e. D2D resource pool), and select resources used for D2D communications based on the measurement results.

FIG. 6 is a flow chart illustrating a procedure for selecting D2D communication resources used by terminals performing D2D communications in a resource management method according to an example embodiment of the present invention.

In FIG. 6, illustrated is an example of a bitmap information exchange procedure performed by a header terminal 610 and a peer terminal 620 between which a D2D communication link is formed among terminals belonging to the same D2D communication group.

Referring to FIG. 6, the header terminal 610 may measure interference level (IoT) of each subband (i.e. DC-R) included in resources allocated for D2D communications (i.e. D2D resource pool), configure bitmap information corresponding to the measurement results, and transmit the configured bitmap information to the peer terminal 620 (S601).

Also, the peer terminal 620 may measure interference level (IoT) of each subband (i.e. DC-R) included in resources allocated for D2D communications (i.e. D2D resource pool), configure bitmap information corresponding to the measurement results, and transmit the configured bitmap information to the header terminal 610 (S602).

Here, interference measurement cycle may be determined according to packer error rate. The packet error rate may mean a rate of packet errors generated from a D2D communication start time to a D2D communication end time while performing D2D communications by using a configured MCS level. Also, the interference measurement may be initiated when a predetermined primitive is transferred from a Radio Resource Control (RRC) layer to a lower layer.

Alternatively, the interference measurement cycle may be configured as a fixed value which is optimally determined according to repetitive experiments.

D2D communication terminals may determine optimal resources used for D2D communications based on the bitmap information exchanged through the procedure shown in FIG. 6.

While the example embodiments of the present invention and their advantages have been described in detail, it should be understood that various changes, substitutions and alterations may be made herein without departing from the scope of the invention.

What is claimed is:

1. A method of resource management, performed in a terminal, the method comprising:
determining resource state of each subband included in resources allocated for device-to-device (D2D) communications, wherein the resources are divided into a plurality of subbands;
configuring resource state information indicating resource state of each subband of the plurality of subbands; and
transmitting the resource state information to a base station.

2. The method of claim 1, further comprising:
receiving information on the resources allocated for D2D communications from the base station,
wherein the information on the resources allocated for D2D communications includes information on a frequency band used for the D2D communications among total uplink frequency bands and information on the subbands into which the frequency band used for the D2D communications is divided.

3. The method of claim 1, wherein the determining resource state of each subband includes
measuring interference level of each subband; and
determing whether the each subband can be used by comparing the interference level with a threshold value.

4. The method of claim 3, wherein the threshold value is determined according to a Modulation and Coding Scheme (MCS) which is applied to the D2D communications.

5. The method of claim 3, wherein the resource state information includes a bitmap each bit of which indicates whether a corresponding subband can be used.

6. The method of claim 1, wherein a size of the bitmap is determined according to a number of MCS levels which are applied to the D2D communications.

7. A method of resource management, performed in a first terminal, the method comprising:
determining resource state of each subband included in resources allocated for device-to-device (D2D) communications, wherein the resources are divided into a plurality of subbands;
configuring first resource state information indicating resource state of each subband of the plurality of subbands;
transmitting the first resource state information to a second terminal;
receiving second resource state information configured by the second terminal from the second terminal; and
determining a resource for the D2D communications based on the first resource state information and the second resource state information.

8. The method of claim 7, wherein the resources allocated for D2D communications are a frequency band selected among total uplink frequency bands, and the frequency band is divided into a plurality of subbands.

9. The method of claim 7, wherein the configuring the first resource state information includes
measuring interference level of each subband;
determing whether the each subband can be used by comparing the interference level with a threshold value; and
configuring the first resource state information including a bitmap each bit of which indicates whether a corresponding subband can be used.

10. A method of resource management, performed in a base station, the method comprising:
allocating a portion of total uplink frequency bands for resources for device-to-device (D2D) communications;
dividing the resources for D2D communications into a plurality of subbands;
transmitting information on the resources for D2D communications and the plurality of subbands to at least one terminal performing the D2D communications;
receiving resource state information on the plurality of subbands from the at least one terminal performing the D2D communications; and
scheduling uplink resources for at least one terminal accessing the base station based on the resource state information.

11. The method of claim 10, wherein the resource state information includes a bitmap each bit of which indicates resource state of a corresponding subband.

12. The method of claim 11, wherein the resource state indicates whether a corresponding subband can be used.

13. The method of claim 11, wherein a size of the bitmap is determined according to a number of Modulation and Coding Scheme (MC S) levels which are applied to the D2D communications.
